(19) United States
(12) Patent Application Publication
(10) Pub. No.: US 2009/0100741 A1
(43) Pub. Date: Apr. 23, 2009

(54) Fishing sinker

(75) Inventor: Takeshi Kitayama, Matsubara-shi (JP)

Correspondence Address: Quinn Emanuel Urquhart Oliver & Hedges, LLP;Koda/Androlia, 10th Floor, 865 S. Figueroa Street, Los Angeles, CA, 90017, US

(73) Assignee: L.S. Kei Corporation

(21) Appl. No.: 12/286,034

(22) Filed: Sep. 26, 2008

(30) Foreign Application Priority Data
Oct. 19, 2007 (JP) 2007-272260

(51) Int. Cl. A01K 95/00

(52) U.S. Cl. 43/44.97

(57) ABSTRACT

A fishing sinker with a curved bottom surface in which concavity(s) is formed in the upper part for attaching bait or simulated bait, thus having a shape that the upper part of the sinker is lighter and the lower part is heavier. A tapered through-hole that passes through the concavity at an angle with respect to the centerline passing through the center of gravity of the sinker is provided in the sinker, and also a detachable fish luring member and underwater fin are attached to the sinker.

### BACKGROUND OF THE INVENTION

1. Field of the Invention

The present invention relates to a fishing sinker and more particularly to a fishing sinker that exhibits hooking effectiveness and fish luring effectiveness, which allows the bait to readily move and which will not readily foul on underwater roots.

2. Description of the Related Art

In fishing, what is most important is somehow attracting the fish to the bait and getting it to bite the bait and take the hook. Accordingly, many different devices have been devised to make the attitude and movement of the bait interesting to the fish, and effect what looks like the natural movement of a living thing.

A sinker, on the other hand, is a device for stabilizing, underwater, a device to which bait and a hook and the like are attached, and for casting that device out into water and causing it to be stationary under the water, and therefore, must be such that the natural movement of the bait described above is not impeded. For that reason, many different innovative measures have been made in the weight, center of gravity position, and shape of such sinkers. In, for example, Japanese Patent Application Laid-Open (Kokai) No. 11-178493, a fishing tackle in which a part of a resin molding is made heavier to act as the sinker part is proposed. As a sinker in which additional functions are imparted, a fishing sinker disclosed in Japanese Patent Application Laid-Open (Kokai) No. 2004-113034 is known, and it has numerous open holes in the interior which are capable of holding fish-gathering substances.

### BRIEF SUMMARY OF THE INVENTION

The object of the present invention is to provide a fishing sinker in which, in addition to the basic functions of a sinker, the bait (including a simulated bait called lures) can move well, the bait is made to move as a living thing, fish luring effectiveness is exhibited by the overall device, the feel of prey fish taking the bait is sensitively transmitted to the fishing line, outstanding hooking effectiveness is exhibited, attitude stability is good, fouling on bottom roots does not readily occur, and the movement of the sinker can be easily controlled from above the water.

More specifically, it is an object of the present invention to resolve the problems described above and to provide a fishing sinker that has a concavity(s) formed in its upper part for attaching bait or simulated bait (lures) (hereinafter collectively referred to as bait) therein.

It is another object of the present invention to provide a fishing sinker that is made in a shape that the upper part is lighter while the lower part is heavier.

It is still another object of the present invention to provide a fishing sinker that has a through-hole provided therein, broad at the tip end, which passes from the surface of the sinker, other than the lower surface thereof that includes the bottom-landing point, to the concavity, through which the fishing line passes.

It is a further object of the present invention to provide a fishing sinker that incorporates a design or luring member for luring prey to the sinker main body or to the vicinity of the bait, and/or an underwater fin attached so as to be replaceable.

In other words, the fishing sinker of the present invention has a curved bottom surface and, in the upper part thereof, a concavity(s) for attaching bait or simulated bait; and further, it is provided with a through-hole (for the fishing line) passing through the sinker with the concavity(s) constituting one end thereof, with diameter of the through-hole varying from one end to another thereof.

Preferably, the through-hole is a tapered hole that broadens toward one end (the concavity end), so that the fishing line and the bait can move good or smoothly relative to the sinker.

Furthermore, it is preferable that the fishing sinker of the present invention be fashioned in a shape in which the orientation of an attached hook is maintained in a certain direction, so that the tightness of the bond between the sinker and the bait is enhanced, the hook orientation is maintained in a certain direction, and the facility that fish are hooked is improved.

The fishing sinker of the present invention may have the concavity and the through-hole covered with a low-friction material to facilitate bait accommodation, so that the movement of the fishing line and bait can be made even better.

Alternatively, the fishing sinker of the present invention may have the outer circumferential portion thereof covered with an elastic material.

In the fishing sinker of the present invention, as seen from the above, a concavity(s) is formed in the upper part for attaching light-weight bait; as a result, the natural movement of the bait is not impeded from the time during which the sinker descends from the water surface or when it has landed at the bottom, the orientation of the hook can be maintained constant, and the device can be maintained in a stable attitude. Also, because the lower part has a curved surface, the sinker will readily wobble due to the movement of the water or changes in tension on the fishing line, and natural movement can be imparted to the bait which is at the upper part. Moreover, since the fishing line passes through the through hole, upward from the lower surface inclusive of the sinker bottom-landing point, and is thus coupled, fishing line movement will not be impeded by being sandwiched between the sinker and the bottom when the sinker has landed on the bottom. Also, since the sinker always has the bottom-landing point at the very bottom, the orientations of the bait and hook are maintained in certain directions, and the hook is prevented from toppling over sideways together with the bait.

In particular, because the fishing line through-hole is a tapered hole, the degree of freedom of movement of the bait and fishing line relative to the sinker is great, the movement of the bait can be made very alive by manipulations to slightly slacken the tension on the fishing line, and manipulations for luring prey can be made easy.

In the fishing sinker of the present invention, moreover, a ring for stabilizing the bait can be provided about the periphery of the concavity; as a result, fish luring members for enticing prey and underwater fins for stabilizing the movement attitude underwater and the like can easily be attached.

In addition, an underwater fin can be provided on the sinker so that it prevents the sinker from turning, and the fin further can prevent the fishing line from becoming tangled or fouling on roots.

### BRIEF DESCRIPTION OF THE SEVERAL VIEWS OF THE DRAWINGS

FIG. 1(a) is a cross-sectional view of a first embodiment, a round fishing sinker, according to the present invention, and FIG. 1(b) is a top view thereof;

FIG. 2(a) is a cross-sectional view of another first embodiment, a gourd-shaped fishing sinker, according to the present invention, and FIG. 1(b) is a top view thereof;

FIG. 3 shows adapters and sinkers to which the adapters are installed;

FIG. 4 shows an example of a second hollow (concavity) in the fishing sinker of the present invention, showing in cross-sections and as a front view, top view, and rear view;

FIG. 5 is an explanatory diagram showing the position of the centers of gravity in a sinker of the present invention.

FIG. 6(a) shows a ring, 6(b) a round sinker, 6(c) the sinker with the ring and a wavering skirt attached, and 6(d) the wavering skirt in a second embodiment of the present invention;

FIG. 7(a) shows a round sinker with a ring, 7(b) shows in cross-section the sinker and the ring separated, and 7(c) shows a top view of the sinker with a wavering skirt attached according to a modified example of the second embodiment of the present invention.

FIG. 8(a) is a top view of a round sinker with a disk-shaped underwater fin, 8(b) is a front view thereof, 8(c) is a top view of a round sinker with an oval underwater fin, and 8(d) is a front view thereof;

FIG. 9(a) is a top view of a round sinker with a substantially triangular shape underwater fin attached according to a modified example of the third embodiment of the present invention, and 9(b) is a front view thereof;

FIGS. 10(a) and 10(b) show a fourth embodiment of the present invention; and

FIGS. 11(a) through 11(d) show modified examples of a fifth embodiment of the present invention.

### DETAILED DESCRIPTION OF THE INVENTION

Embodiments of a fishing sinker according to the present invention will be described below in detail with reference to the accompanying drawings.

### First Embodiment

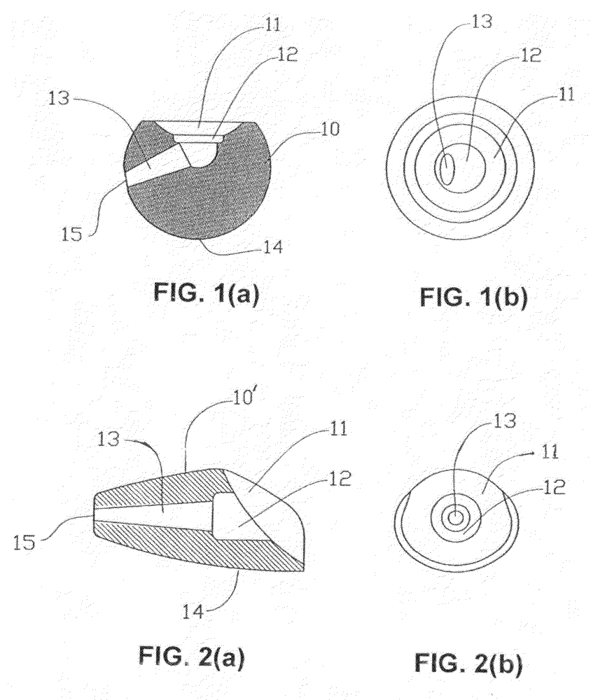

FIG. 1(a) through FIG. 2(b) are diagrams of a first embodiment of the present invention, in which FIG. 1(a) shows a cross-section of a round sinker 10, FIG. 1(b) is a top view thereof, FIG. 2(a) shows a cross-section of a gourd-shaped sinker 10′ having a fan-shaped cross-section, and FIG. 2(b) is a rear view thereof.

The sinker 10 (10′) is made of a material such as a metal or resin having a heavier specific gravity than water, and it has what is substantially a spherical shape (FIG. 1(a)) or a gourd-like shape (FIG. 2(a)). The sinker 10 (10′) is provided with hollows (concavities) 11 and 12 formed in portions of the outer surface and a through-hole 13 formed therein so that it passes through the sinker from the bottom of the hollow (concavity) 12.

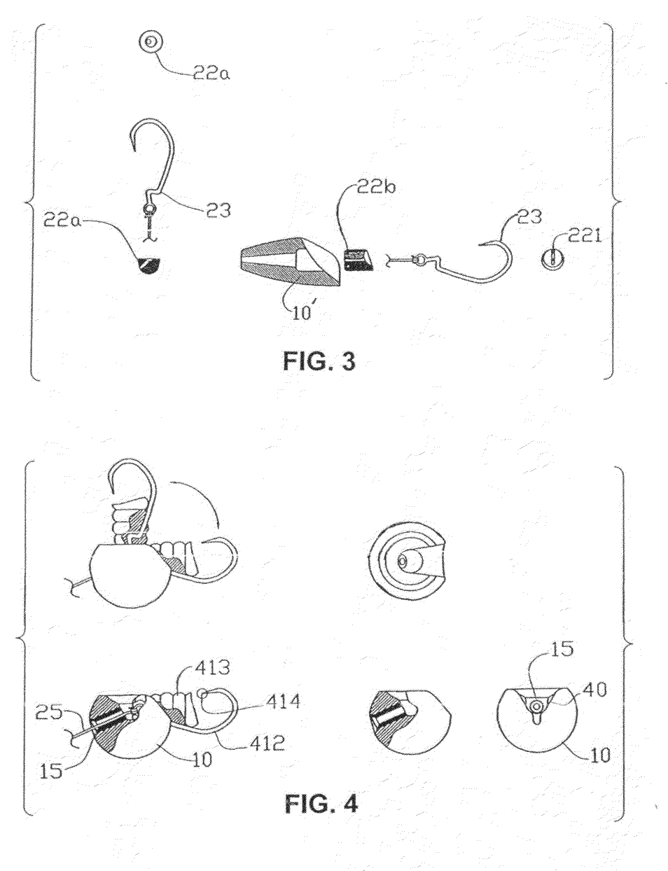

The hollow (concavity) 11, which is for accommodating bait, has a semicircular shape, and it may have a plurality of steps formed therein. The depth of the hollow (concavity) 12 is not particularly limited; however, it should nevertheless be of such extent that the bottom thereof reaches the center of gravity of the sinker, and both the size of the sinker and the depth of the hollow (concavity) can be freely selected according to the size of the bait or simulated bait used or the water depth in view. For the method of guiding or securing the bait to the hollow (concavity) 11, provision may be made so that the tip end of the bait is fit into the hollow (concavity) 11, with the bait hooked onto the hook attached to the fishing line, or an adapter 22a or 22b may be provided inside the hollow (concavity) 12 as shown in FIG. 3, where the reference numeral 22a is an adapter for a spherical sinker, 22b is an adapter for a gourd-shaped sinker, and 23 is a hook. The reference numeral 221 is a slit into which the hook 23 is fit, and the adapter 22a or 22b can be replaced by a wavering skirt 32 (see FIGS. 6(c) and 6(d)).

As shown in FIG. 4, moreover, a second concavity 40 may be formed. This second cavity 40 is provided in an adjacent surface crossing in a direction perpendicular to the concavity in a direction substantially opposite to that of the through-hole which passes the fishing line of the sinker, and a hook 412 and a bait 413 are fit therein. A slit 41 may also be formed in the concavity 40 so that it accommodates the hook 412. With this structure, the hook tip 414 is able to always be maintained so as to be oriented upward. The size and depth of the second concavity 40 and slit 41 can be freely changed according to the size of the sinker, the size of the bait used, and the size of the hook.

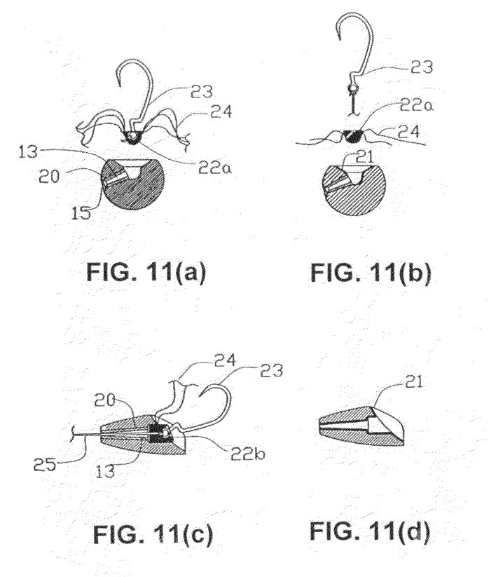

The adapter 22 or the second concavity 40 functions to enhance the movement of the bait while tightly contacting the bait and the sinker to each other, and to which a fish luring member 24 (see FIG. 11(a)) called a skirt for attracting the attention of fish can be fitted. The skirt (fish luring member) 24 can be easily and suitably exchanged to match the type of prey and condition of the fishing ground or the like.

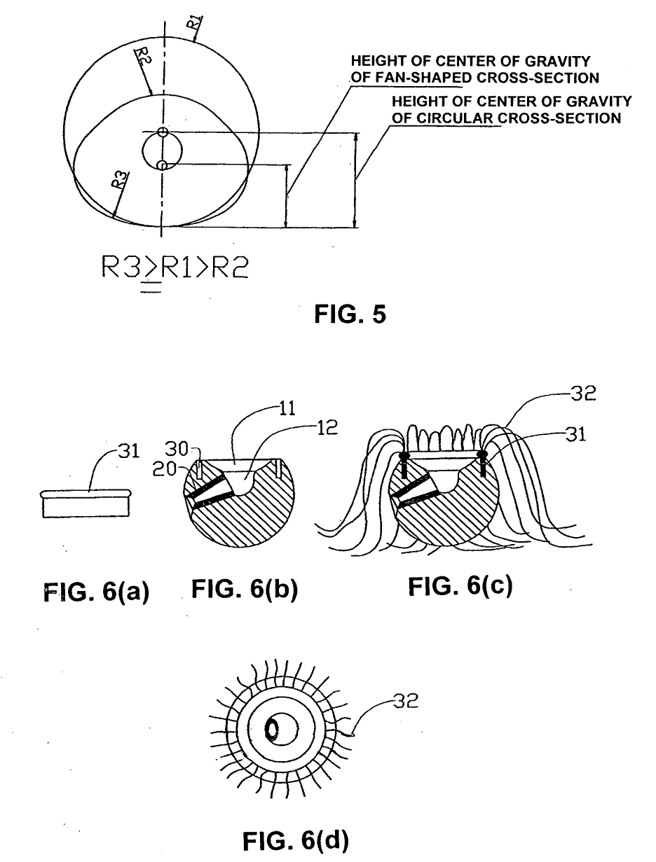

The sinker 10 (10′) is further provided with a through-hole 13. The through-hole 13, a hole for passing the fishing line, is formed so that, when its start point is made the bottom of the hollow (concavity) 12, the end point 15 is a position away from a point 14 (hereinafter called the “location point”) at which a perpendicular line (see FIG. 5) passing through the center of gravity of the sinker crosses the outer surface of the sinker. In the sinker shaped as shown in FIG. 2, the end point 15 should be at a position that is more forward than the location point.

The shape of the through-hole 13 is tapered so that the hole broadens (the diameter becomes larger) toward the start point (which is, as described above, at the bottom of the hollow (concavity) 12) from the end point 15, as seen from FIG. 1(a) and FIG. 2(a), so that when the bait sticks out slightly to the rear (on the end point 15 side) from the hollow (concavity) 11, the bait and the fishing line can wobble freely. Moreover, when, from that condition, the angler pulls the fishing line in, the taper-shaped hole 13 will become a guide, so that the fishing line will meet little resistance in passing through the sinker, and the bait will be drawn to the hollow (concavity) 11 without the attitude of the sinker changing.

As described above, with the end point 15 of the through-hole 13 located at a position away from the lower surface containing the location point 14, the bait can be maintained in a condition of being raised up from the bottom, even when the fishing line 25 (see FIG. 4) is being pulled, and fish can be effectively lured in. In contrast therewith, when the end point 15 of the through-hole 13 is near the location point 14, the bait can be maintained in an upward oriented attitude when the line 25 is slack; however, when the line 25 is being pulled, the sinker will topple over sideways on the bottom with the bait in a poor attitude, and the effect of luring fish in will be lost. Furthermore, with the above-described construction, the sinker itself can readily fall over sideways, making control in the water difficult to effectively manage, and also causing root fouling to occur often.

The fishing sinker 10 (10′) of this embodiment is designed so that the lower part is heavier than the upper part, and the lower part is spherical. Accordingly, stabilized sinker action is possible, wobble is readily imparted thereto by the movement of the water or pulling tension on the line, and natural movement can be imparted to the bait.

As seen from the above, the shape of the fishing sinker 10 (10′) of this embodiment is: (1) the bottom part is a curved surface, (2) a hollow (concavity) is formed in the upper part, and (3) a tapered through-hole is formed from the bottom of the hollow (concavity) so as to subtend an angle with the centerline passing through the center of gravity of the sinker. As long as the above features are satisfied, many different modifications are possible. FIG. 5 shows an example of a gourd-shaped sinker having a fan-shaped cross-section and low center of gravity. The gourd-shaped sinker that has a low center of gravity as shown in FIG. 5 readily adopts a desirable attitude, when it has descended through the water and landed on the bottom, with the bait oriented upward.

In addition to shape modifications, other functions can also be added. Embodiments of the present invention having other functions added based on the sinker of the first embodiment will be described below.

### Second Embodiment

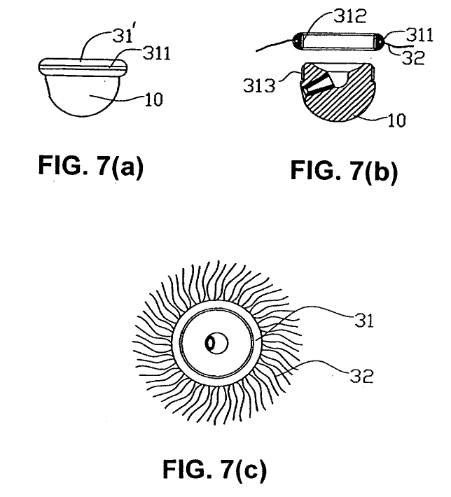

FIGS. 6(a) through FIG. 7(b) show a second embodiment of the sinker of the present invention, in which a ring-shaped channel 30 is formed in the surface of a sinker where the hollow (concavity) 11 is provided, and a ring 31 is fit in the channel 30. The ring 31 may be secured to the channel 30 by, for example, making the diameter and width of the channel 30 substantially the same as the diameter and width of the ring 31 so that the ring 31 is pushed into the channel 30 and secured therein. The ring 31 can be threadably secured to the channel 30.

The sinker shown in FIGS. 6(c) and 6(d) employs such a ring 31, and it has further a wavering skirt 32 secured in the channel 30. In this structure, in addition to the effect of the sinker itself moving, a fish luring effect is obtained by the wavering of the skirt 32. FIG. 6(a) is a front view of the ring 31, FIGS. 6(b) and 6(c) shows the cross-sections of the sinker provided with the channel 30 and skirt 32, respectively, and FIG. 6(d) is a top view of the sinker having the skirt 32.

FIGS. 7(a) through 7(c) show a sinker provided with a ring 31′ that is formed with a channel 311 in the outer circumference thereof. The ring 31 is detachably attached to the sinker by screwing, and a skirt 32 is fitted tightly in the channel 311 of the ring 31. In this structure, the skirt 32 can be exchanged quickly according to the circumstances.

FIG. 7(a) is a side view of the sinker 10 attached with the ring 31, 7(b) is a cross-section thereof (with the ring 31′ and the sinker 10 shown separately) with an internal screw formed in the ring 31′ and an external screw 313 formed on the sinker 10, and 7(c) is top view thereof with the skirt 32 attached.

### Third Embodiment

In a third embodiment of the present invention, based on the sinker of the first embodiment, the sinker is provided with an underwater fin added to the upper part.

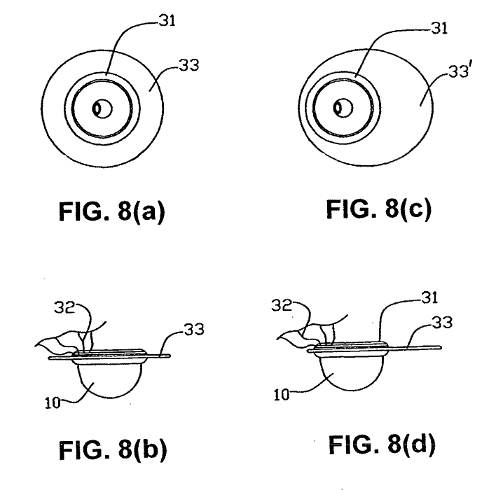

FIG. 8(a) is a top view of the sinker 10 equipped with a disk-shaped underwater fin 33, and 8(b) is a front view thereof; and FIG. 8(c) is a top view of the sinker 10 equipped with an oval underwater fin 33′, and 8(d) is a front view thereof.

The underwater fin 33 (33′) can be secured directly to the outer circumference of the sinker 10, or the underwater fin 33 (33′) is secured to a threaded ring. In the latter case, changes to an underwater fin having a desired shape, size, and weight according to the circumstances can easily be made.

With such an underwater fin 33 (33′), when an angler pulls on the fishing line and draws the sinker in the water closer, a floatation force is applied to the sinker; as a result, the tendency thereof to travel straight is increased, and the sinker is prevented from toppling over sideways on the bottom; in addition, obstacles can be nicely maneuvered around, and root fouling can be prevented. With a use of an underwater fin 33 (33′) that is made of an elastic material, moreover, root fouling can be prevented even more effectively, even when an obstacle is snagged, by using the bending recoil force of the elastic material.

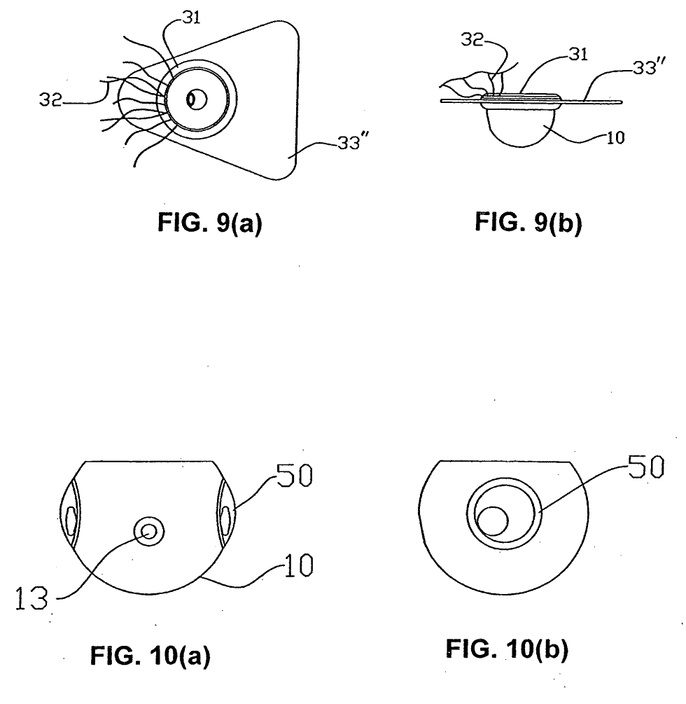

This embodiment is not limited to the one shown in FIGS. 8(a) through 8(d); and it is possible to make various modifications to the shape or color of the sinker and/or fin. As shown in FIGS. 9(a) and 9(b), for example, the fin 33 (33′) can be made in a substantially triangular shape fin 33″. It is also possible to use a transparent material for the underwater fin so as not to seem strange to the fish, or, conversely, to make the fin stand out with color(s).

FIG. 9(a) is a top view of the sinker with the fin 33″, and 9(b) is a side view thereof.

### Fourth Embodiment

In the fourth embodiment of the present invention, based on the sinker of the first embodiment, an artistic design is effected in the outer circumferential part of the sinker.

FIG. 10(a) is a front view of the sinker of the fourth embodiment in which a fish eye-shaped member is attached as an artistic design, and 10(b) is a side view thereof.

In this embodiment, by applying (painting, for instance) designs of various colors on the outer circumferential part of the sinker, or coating the surface with a light-reflecting film, or the like, it is possible to effect natural designs that will not seem strange to the fish, or, conversely, to make the sinker and/or fin stand out.

### Fifth Embodiment

Next, a fifth embodiment of the present invention will be described.

The fishing sinker in this embodiment is substantially the same as the sinker in the first embodiment insofar as having a tapered through-hole therein; however, it is characterized in that the inner surface of the through-hole is covered with a soft, low-friction resin or rubber material. Additionally, the inner surface of the hollow (concavity) may also be covered with the same material. With such a configuration, the movements of the fishing line and bait are enhanced and wear is prevented.

Examples of the sinker of this embodiment are shown in FIGS. 11(a) to 11(d).

FIG. 11(a) shows a round sinker wherein, in the through-hole 13, a tube 20 made of a resin such as silicone rubber or polytetrafluoroethylene which has elasticity and little friction is installed. The tube 20 protects the fishing line. FIG. 11(b) shows a round sinker in which the hollows (concavities) (11 and 12) and the through-hole (13) are coated with a low-friction resin film 21. With these configurations, wear in the fishing line and bait is reduced, and bait movement is further improved.

FIG. 11(c) shows an example in which a tube 20 is mounted in a gourd-shaped sinker; and in the sinker of FIG. 11(d), a coating 21 is effected for a gourd-shaped sinker.

In this embodiment as well, an adapter 22a or 22b may be attached which fits into the hollow (concavity) 12, and a skirt 24 fitted thereto. Various skirts 24 are easily and appropriately selected to accord with the type of prey or the conditions of the fishing ground or the like.

The foregoing first to fifth embodiment are described as basic configurations of the fishing sinker of the present invention. However, it is possible to add to the sinkers of these embodiments functions to further enhance the floatation forces of the upper part or functions for preventing root fouling, and the like.

### Sixth Embodiment

Next, an embodiment will be described wherein the material of the fishing sinker of the present invention is the characteristic.

So as to efficiently manufacture fishing sinkers of the present invention that have complex shapes, casting those in lead, which has a large specific gravity, works well; however, lead is a toxic metal which may cause environmental pollution, and it is undesirable to use it.

In view of the above, in the sixth embodiment of the present invention, injection molding is employed in which, for the material of the fishing sinker of the present invention, a raw material is used such as a resin material wherein particles of a metal of large specific gravity are mixed, or a mixture of metal powder and a binder material. With injection molding, not only can manufacture be done efficiently, even when the product has a complex shape or is small; however, because the metal particles mixed in can be covered with a resin, and molding can be done with a shaped body using a natural mineral alloy from which chemicals have been removed. The product, thus, is one in which it is kind to the environment, toxic substances are not dissolved out, to the outside, in water.

Moreover, by covering at least partially the sinker of the present invention with a soft, elastic material, a root fouling prevention function can be imparted. When the sinker has snagged on such an obstacle as a rock or plant or the like on the bottom, the obstacle can be slid away from by the outside elastic material bending when the fishing line is strongly pulled in, so that the loss of the device is prevented. Also, wasteful use of valuable mineral resources for the sinker can be decreased, leading to resource conservation.

Because this embodiment can be applied to all fishing sinkers of the present invention described above, including the first to fifth embodiments, no particular diagram thereof is given herein.

As seen from the above, according to the fishing sinker of the present invention, the lower surface of the sinker is spherical or substantially spherical, and thus the sinker can wobble with a slight water flow or line tension, and fish can be attracted. In addition, by securing the bait in the hollow (concavity), the hook that is thereby hidden in the interior will stand up without falling over on the bottom, and thus it is easy for the fish to swallow, making the probability of a catch higher. Also, it is possible to apply slight changes to the tension on the fishing line so that the bait can be made to wobble to lure fish in without changing the position of the sinker. If the fishing line is slackened, moreover, the fishing line will wobble inside the tapered hole and greater movement can be imparted to the bait.

When the fishing line is pulled and the sinker pulled in closer on the bottom, an outstanding tendency to travel straight is realized by the function of the underwater fin; and since appropriate floatation forces are given by the fin, root fouling and fishing line tangling and the like can be prevented.

It is also possible to quickly and flexibly change the bait and the fish-luring skirt surrounding the bait in response to the condition of the fishing ground.

1. A fishing sinker comprising:
a curved bottom surface,
a concavity provided in an upper part of said sinker for attaching at least one of a portion of bait, a simulated bait and a hook, and
a through-hole provided so as to pass through said sinker with said concavity forming one end of said through-hole, a diameter of said through-hole varying from said one end to another end.

2. The fishing sinker according to claim 1, wherein
a diameter of said through-hole at said one end is larger than a diameter at said another end.

3. The fishing sinker according to claim 1, wherein
said sinker is made of a material in which one of a resin and a binder material mixture is mixed together with a metal, and
said sinker is formed by one of injection molding and sintering.

4. The fishing sinker according to claim 1, wherein
said through-hole is formed such that at least a portion thereof is inclined from a centerline passing through a center of gravity of said sinker.

5. The fishing sinker according to claim 1, wherein
a protective means for protecting a fishing line is provided in one of said concavity and said through-hole.

6. The fishing sinker according to claim 1, wherein
at least one of a part of said concavity and a vicinity thereof is shaped so as to guide or fix an orientation of a hook in a certain direction.

7. The fishing sinker according to claim 1, wherein
a cross-section taken along an axis of said through-hole is substantially fan-shaped, and
an area of said cross-section varies from one end to another of said through-hole.

8. The fishing sinker according to claim 1, further comprising a ring-shaped channel formed in an outer circumference of said concavity for receiving therein a ring member.

9. The fishing sinker according to claim 8, wherein
said ring member is secured to said ring-shaped channel.

10. The fishing sinker according to claim 1, further comprising an underwater fin attached to an outer circumference of said concavity.

11. The fishing sinker according to claim 1, wherein
an artistic design is effected-on an outer circumference of said sinker.
